(19) United States
(12) Patent Application Publication
(10) Pub. No.: US 2022/0188927 A1
(43) Pub. Date: Jun. 16, 2022

(54) TRANSPORTABLE, EXTENDABLE, SELF-CONTAINED NATURAL CAPITAL MANAGEMENT FACILITY AND METHOD OF USE OF SAME TO PROCURE, ASSESS, MANAGE, AND TRADE NATURAL CAPITAL

(71) Applicant: Lauri Edwina Elliott, (US)

(72) Inventor: Lauri Edwina Elliott, Raleigh, NC (US)

(73) Assignee: Lauri Edwina Elliott, Raleigh, NC (US)

(21) Appl. No.: 17/552,411

(22) Filed: Dec. 16, 2021

Related U.S. Application Data
(60) Provisional application No. 63/126,477, filed on Dec. 16, 2020.

(51) Int. Cl. G06Q 40/04; G06Q 50/06

(52) U.S. Cl. CPC G06Q 40/04; F24F 8/00; G06Q 50/06

(57) ABSTRACT

A transportable, extendable, self-contained natural capital management and trade facility that is completely equipped to procure, assess, manage, trade, and leverage natural capital from almost anywhere in the world, in an example embodiment of being housed in a standard shipping container. A transportable, extendable, self-contained natural capital management and trade facility and method of use of same to procure, assess, manage, trade, and leverage natural capital generally consists of a self-contained facility; a natural capital management software; field operations; globally available capital transaction platform; and a method to procure, assess, manage, trade, and leverage natural capital.

### CROSS REFERENCE

The embodiments herein claim the priority of the U.S. patent application (provisional) filed on Dec. 16, 2020, with the Ser. No. 63/126,477.

### BACKGROUND

### Field of Invention

This application is generally directed towards facilities to manage, trade, and leverage natural capital and more specifically it relates to a transportable, extendable, self-contained natural capital management and trade facility housed in a standard shipping container that may operate almost anywhere in the world. Other components of the invention include, but are not limited to: field operations; a natural capital management software; a globally available natural capital transaction platform; and a method to procure, assess, manage, trade, and leverage natural capital.

The invention possesses numerous benefits and advantages over known options. In particular, the invention is used to execute a variety of natural capital management activities, such as procure, assess, trade, leverage, pool, and track and trace, instead of one or a few natural capital management activities. Moreover, the invention may be used to manage more than one type of natural capital, such as precious metals or agriculture, and other forms of capital, such as human, social, built-environment, and intellectual. Because of its design to perform a variety of management activities on a variety of natural, and other forms of, capital in a variety of adaptive and flexible configurations for a variety of physical environments, the invention manages natural capital, and other forms of, capital more holistically which is increasingly important.

A practical example of the usefulness of the invention is the multi-dimensional aspects of buying a commodity. No longer is it sufficient to obtain a seller's identification and estimate from where the commodity comes, including remote and rural areas. International standards seek transparency on: people; a commodity; the land from which a commodity came; the conditions under which a commodity is produced or extracted; the conditions under which local people and producers live; how the production process of a commodity impacts the environment; and other dimensions. Coupled with increased expectations of ongoing monitoring and mitigation of negative externalities, facilities only able to handle a few scenarios are not sufficient. The invention is, therefore, suited for environments where flexibility, adaptability, extensibility, or extendability is needed to handle multi-dimensional management for natural capital, other forms of capital, and combinations of capital.

In addition to the aforementioned attributes, the invention holds numerous electrical, networking, analysis, and security benefits over conventional designs. Electrical features allow for on-grid or off-grid generation, using a variety of energy sources like solar, diesel, or grid electricity.

Network features include an in-facility hard-wired network, wi-fi network for a facility site, and local wireless broadband covering many miles at once, connecting field operations with a self-contained facility and allowing for natural capital management away from a self-contained facility, housed in a shipping container. When other embodiments of the invention, such as a vehicle-based facility, are used in conjunction with a self-contained facility housed in a shipping container, the network features integrate each facility into a unified operations cluster.

A key analysis feature is using analysis instruments, such as an XRF analyzer, that may be used to analyze a wide variety of materials. Security features include: biometric identification and access; separating facility operators from clients and clients from each other; and video surveillance and lighting on both the inside and outside of a self-contained facility. These security features increase the security of the invention.

### Description of Prior Art

Capital is differentiated from assets here, meaning things, including assets, that are put to productive use or used as part of a productive process such as business. Natural capital is natural resources stock, land, and ecosystems. Any use of natural capital increasingly requires proper management, which is more difficult in rural and remote areas.

A few aspects of managing natural capital are assessing and trading. In prior arts US Patent US2014122376A1, issued May 1, 2014, and U.S. Pat. No. 9,679,317 B2, issued Jun. 23, 2017, to Noyes, the invention is a mobile facility designed to assay precious metals.

Other aspects of managing natural capital are monitoring and valuating. For remote and rural areas, the predominate methods of monitoring are remote sensing and human-initiated activities. In addition, mobile laboratories are generally designed for a single use, such environmental monitoring, as part of a sample program to monitor natural capital. In prior art Great Britain Patent 2010050589W, issued Apr. 6, 2010, to Shipley and Hagan, an apparatus and method is established for automatically valuing articles placed in the apparatus and concluding transactions.

Existing facilities, apparatuses, systems, and methods are unable to sufficiently and systematically procure, assess, manage, trade, and leverage a variety of differing types of capital flexibly, particularly from areas with a lack of infrastructure such as rural and remote areas. Many of these areas hold the keys to earth's future in natural resources but also are often home to people with limited opportunities. Through proper management of natural, and other forms of, capital, opportunities will increasingly come to people in remote and rural areas and natural, and other forms of, capital will be available to empower economies and society.

This specification recognizes that there is a need for a transportable, extendable, self-contained natural capital management and trade facility that is completely equipped to assess, manage, trade, and leverage natural, and other forms of, capital from almost anywhere in the world.

### SUMMARY

An example embodiment of the present invention is directed to a natural capital management and trade facility, housed in a standard shipping container, consisting of: a self-contained facility; a natural capital management software; field operations; globally available capital transaction platform; and a method to procure, assess, manage, trade, and leverage natural capital.

There has thus been outlined, rather broadly, some of the features of a transportable, extendable, self-contained natural capital management and trade facility and method of use of same to procure, assess, manage, trade, and leverage natural capital in order that the detailed description thereof may be better understood, and in order that the present contribution to the art may be better appreciated. There are additional features of a transportable, extendable, self-contained natural capital management and trade facility and method of use of same to procure, assess, manage, trade, and leverage natural capital that will be described hereinafter and that will form the subject matter of the claims appended hereto. In this respect, before explaining at least one embodiment of a transportable, extendable, self-contained natural capital management and trade facility and method of use of same to procure, assess, manage, trade, and leverage natural capital in detail, it is to be understood that a transportable, extendable, self-contained natural capital management and trade facility and method of use of same to procure, assess, manage, trade, and leverage natural capital is not limited in its application to the details of construction or to the arrangements of the components set forth in the following description or illustrated in the drawings. A transportable, extendable, self-contained natural capital management and trade facility and method of use of same to procure, assess, manage, trade, and leverage natural capital is capable of other embodiments and of being practiced and carried out in various ways. Also, it is to be understood that the phraseology and terminology employed herein are for the purpose of the description and should not be regarded as limiting.

One objective is to provide a transportable, extendable, self-contained natural capital management and trade facility and method of use of same to procure, assess, manage, trade, and leverage natural capital.

Another objective is to provide a transportable, extendable, self-contained natural capital management and trade facility and method of use of same to procure, assess, manage, trade, and leverage natural capital that provides a secure, cohesive, durable, and transparent operation.

Another objective is to provide a transportable, extendable, self-contained natural capital management and trade facility and method of use of same to procure, assess, manage, trade, and leverage natural capital that provides a provenance, tracking, and tracing system that originates at or near the source of natural capital and enables tracking and tracing of extracted or harvested natural capital, or a derivation, from source of natural capital through to end users.

Another objective is to provide a transportable, extendable, self-contained natural capital management and trade facility and method of use of same to procure, assess, manage, trade, and leverage natural capital that provides a platform to leverage the value, features, or functions of natural capital without trading it in a variety of transactions, projects, and activities.

Another objective is to provide a transportable, extendable, self-contained natural capital management and trade facility and method of use of same to procure, assess, manage, trade, and leverage natural capital that provides an integrated means of physically and virtually managing and monitoring natural capital assets, and other physical capital.

Another objective is to provide a transportable, extendable, self-contained natural capital management and trade facility and method of use of same to procure, assess, manage, trade, and leverage natural capital that provides infrastructure for on-grid and off-grid operation.

Another objective is to provide a transportable, extendable, self-contained natural capital management and trade facility and method of use of same to procure, assess, manage, trade, and leverage natural capital that provides a platform for capital transactions and activities, which may be accessed and used by users from anywhere in the world.

Another objective is to provide a transportable, extendable, self-contained natural capital management and trade facility and method of use of same to procure, assess, manage, trade, and leverage natural capital that enables natural capital to be pooled with other forms of capital, such as human, intellectual, and equipment, to form unique asset pools that may be used for a variety of activities and transactions, such as securitization instruments for financial transactions.

Another objective is to provide a transportable, extendable, self-contained natural capital management and trade facility and method of use of same to procure, assess, manage, trade, and leverage natural capital that enables users to monitor and manage their preservation, development, risk management, and use of natural capital from its source through a supply chain and to end users.

Other objectives and advantages of the various embodiments of the present invention will become obvious to the reader and it is intended that these objectives and advantages are within the scope of the present invention. To the accomplishment of the above and related objectives, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

In the Figures, similar components and/or features may have the same reference label and are optionally relabeled in similar Figures. Further, various components of the same type may be distinguished by following the reference label with a second label that distinguishes among the similar components. If only the first reference label is used in the specification, the description applies to any of the similar components having the same first reference label despite the second reference label's presence or absence in the description.

FIG. 1 is a right side view of the structure of a standard shipping container of an example embodiment of the present invention. The drawing is a representation of a standard shipping container with double doors [103] on the front side and on the rear side.

FIG. 2 is end views of the structure of a standard shipping container of an example embodiment of the present invention. The drawing is a representation of end views, which are a front entry [105] and a rear entry [106] into a facility [101] housed in a standard shipping container.

FIG. 3 is a top view and end view of the present invention. The drawing is a representation of a top view and end view of the external structure of a facility [101] housed in a standard shipping container, which has a solar array [113] on a shipping container's roof [131] and extending to create an overhang [129].

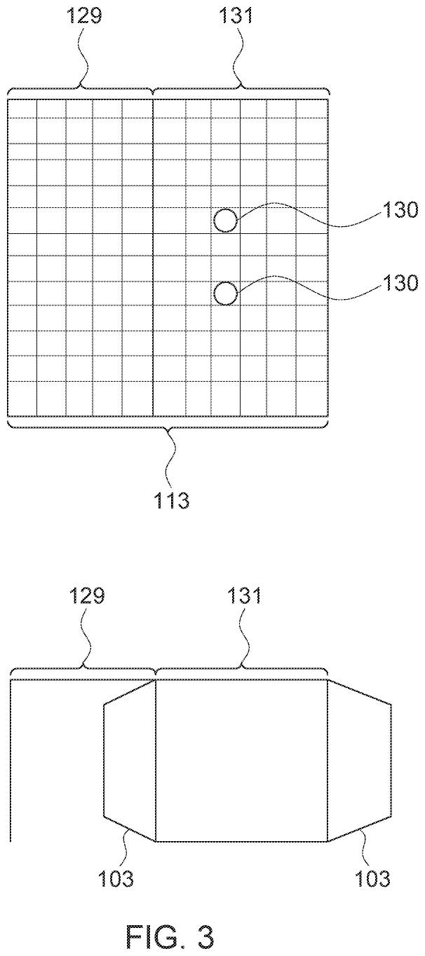

FIG. 4 is a top view of the present invention. Drawing is a representation of a top view of external edges and interior of a facility [101] in a standard shipping container, illustrating interior elements.

FIG. 5 is a front view of the present invention. Drawing is a representation inside a client compartment [110] with two client cubicles [120], which face, and display to a client, a work compartment [111] where facility operators work. Drawing illustrates elements of interior area of a client compartment [110].

FIG. 6 is a rear view of the present invention. Drawing is a representation of a rear view facing toward the front, facing and displaying two client cubicles [110] in a client compartment [110], from within a commercial sub-section [147] in a work compartment [111]. Drawing illustrates elements of interior area of a facility operator commercial counter [121] in a commercial sub-section [147] of a work compartment [111].

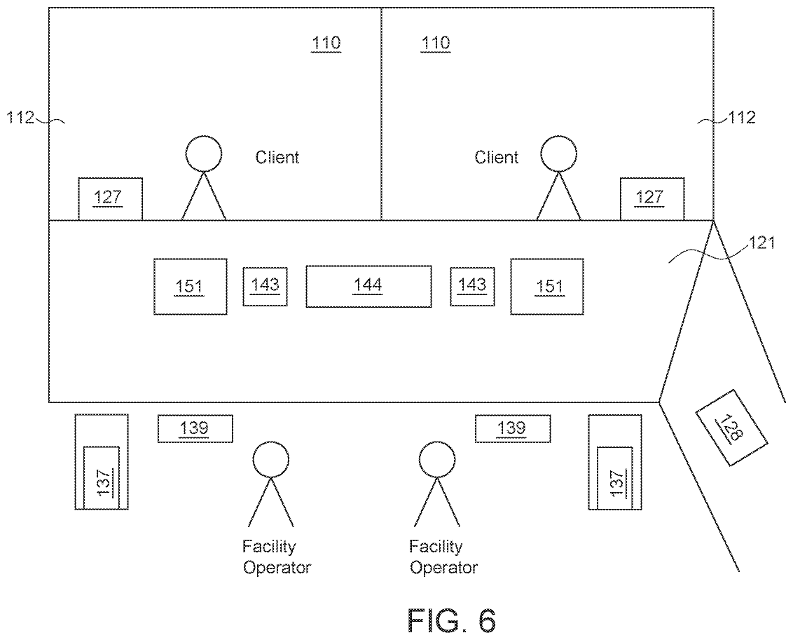

FIG. 7 is a right side view of the present invention. Drawing is a representation of an arrangement of a work compartment [111] on the right side inside a standard shipping container.

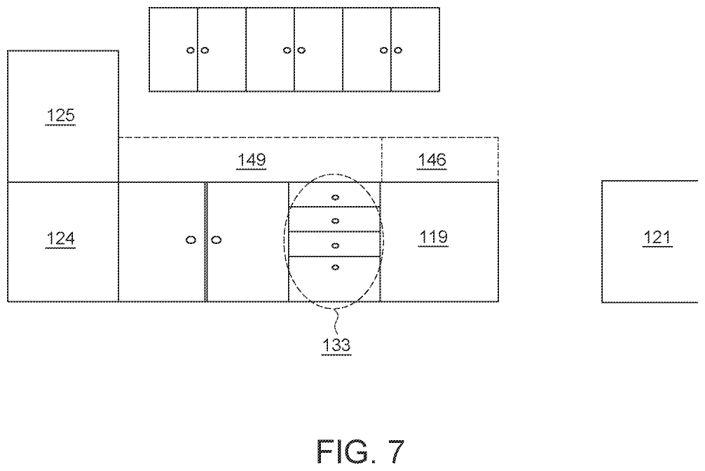

FIG. 8 is a left side view of the present invention. Drawing is a representation of an arrangement of a work compartment [111] on the left side inside a standard shipping container.

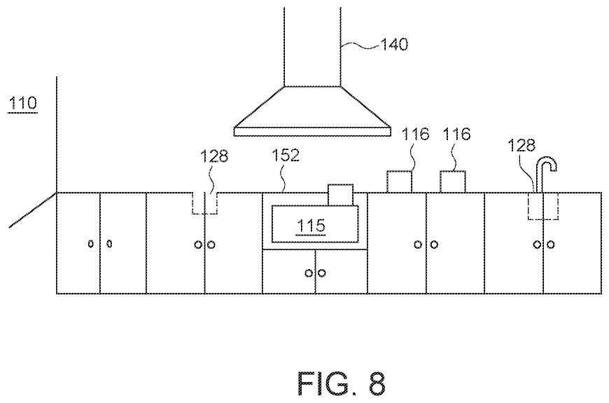

FIG. 9 is a representation of the process components of a natural capital management software [200].

FIG. 10 is a representation of functions within an object onboarding process component [201] in a natural capital management software [200].

FIG. 11 is a representation of functions within an object management process component [202] in a natural capital management software [200].

FIG. 12 is a representation of functions within a transactions process component

in a natural capital management software [200].

FIG. 13 is a representation of functions within a systems/component management process component [204] in a natural capital management software [200].

FIG. 14 is a representation of a natural capital management software main screen

in a natural capital management software [200].

FIG. 15 is a representation of a capital profile [206] main screen and filtered relationships that link it to object assessment [224], object inventory management [225], and object valuation [226] main screens, which are linked to an object management process component [202] in a natural capital management software [200].

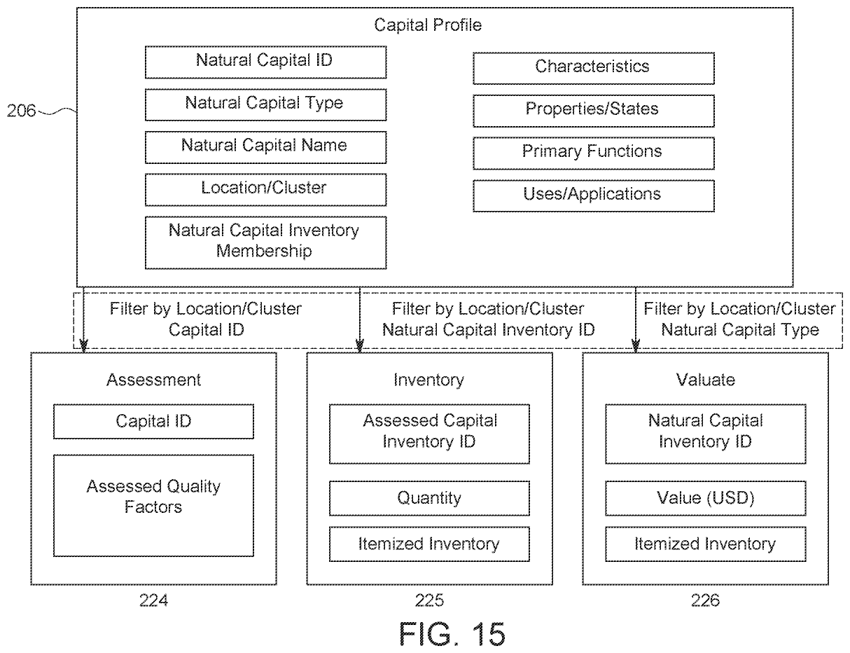

FIG. 16 is a representation of a pool [210] main screen, which is linked to a transactions process component [203] in a natural capital management software [200].

FIG. 17 is a representation of a trade [211] main screen linked to a transactions process component [203] in a natural capital management software [200].

FIG. 18 is a representation of a leverage [212] main screen linked with a transactions process component [203] in a natural capital management software [200].

FIG. 19 is a representation of a track or trace [213] main screen linked to a transactions process component [203] in a natural capital management software [200].

FIG. 20 is a representation of a transaction flow [300] employing the invention and connecting different components of the invention in a flow [242].

FIG. 21 is a representation of elements that flow into a natural capital management software [200].

### DETAILED DESCRIPTION

Turning now descriptively to the drawings, in which similar reference characters denote similar elements throughout the several views, the figures illustrate an example embodiment comprising a self-contained facility; a natural capital management software; field operations; globally available capital transaction platform; and a method to procure, assess, manage, trade, and leverage natural capital.

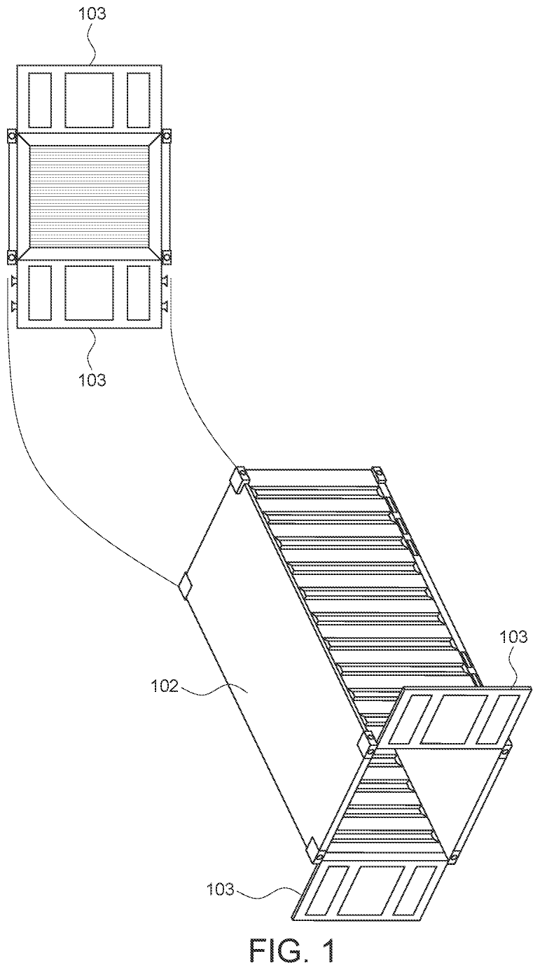

The physical manifestation of a facility [101] of the example embodiment is housed in a standard (ISO) shipping container, a transportable structure [102]. A standard shipping container measures 8×8×20 feet and has double doors [103] on both ends of a shipping container, represented in FIG. 1. Certain mechanisms are built into the invention to ensure it is operating in the way it should, and if not, ensure that issues can be readily identified, communicated, and addressed. These mechanisms include: best practices; protocols; guidelines like the Guideline for the Safe Use of ISO Intermodal Shipping Containers Repurposed as Buildings and Building Components (ICC G5-2019); standards like Testing and Calibration Laboratories (ISO/IEC 170250); sensors [156], meters [157], and other devices that log, monitor, and alert conditions and events related to elements, activities, and other items in the invention; and other mechanisms to fulfill the purpose and objectives, such as a secure and transparent operation, of the invention.

The use of a standard shipping container as a transportable structure [102] for the invention means the invention is transportable almost anywhere. There are global transport and logistics networks designed for intermodal, steel shipping containers. A shipping container may be transported and moved between different modes of transportation, including rail, ship, semi-truck, aircraft, and other modes readily.

The construction of a standard shipping container enables a durable operation by protecting a facility [101] from, and minimizing the effects of, the external physical environment such as weather. The steel construction of a standard shipping container makes it suitable for a variety of on land or underground terrestrial environments. The invention may be adapted to operate in almost any environment, including in space or under water. To operate in various environments, structures, systems, and other components may be needed to protect, float, or perform other functions, so that the invention may successfully operate. Unconventional transport modes or systems, such as a space shuttle or a rocket, may be needed to transport and deliver the invention.

B. Self-Contained Facility [101]

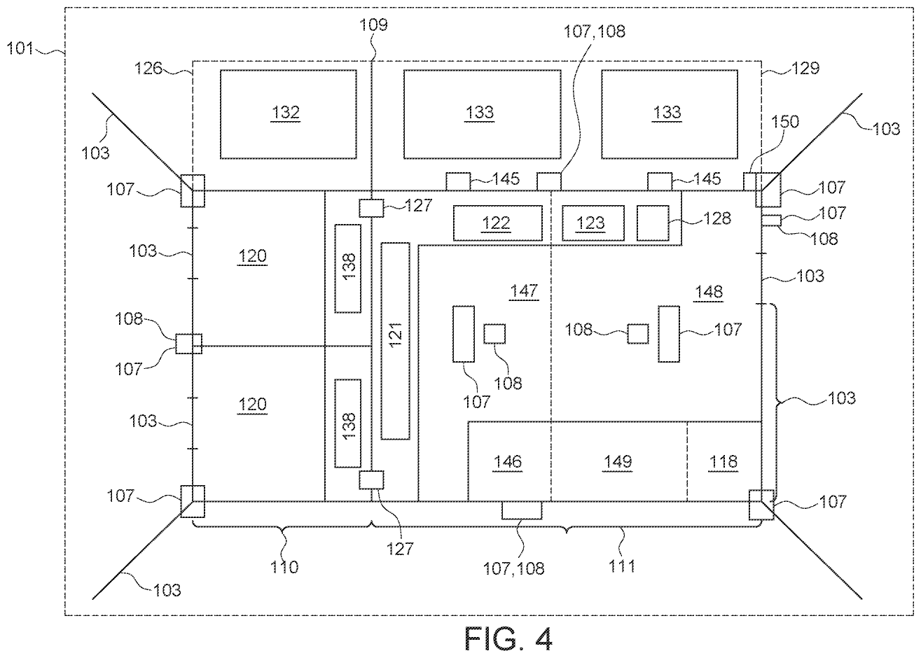

A self-contained facility [101], represented in FIG. 4, is completely equipped to procure, assess, manage, trade, and leverage natural capital in an arrangement that provides secure and transparent operations whether on-grid or off-grid. Structural, or non-structural, modifications to a standard shipping container, in which a facility [101] is housed, includes: modified front entry [105] and rear entry [106]; lighting systems [107] and video surveillance systems [108] inside and outside for visibility and security; a structural wall

dividing client compartment [110] and work compartment [111]; a non-structural wall [109] dividing client cubicles; a penetration-resistant window [112] embedded in a structural wall [109], which sits between a client compartment [110] and a work compartment [111]; solar array [113] on a roof [131] of a shipping container housing a facility [101], providing a covered outside pavilion [126] and power [150] for off-grid operation when needed; doors [103], which lead into interior areas of a facility [101], outfitted with access control systems [104]; and other modifications.

The interior of a facility [101] is outfitted with an induction furnace [115] for processing precious metals; material analysis instruments [116], such as an XRF analyzer, which enable the elemental analysis, characterization, and assessment of a variety of natural capital or materials; a data center [117] which houses a network, computing, data, communication, and application infrastructure [118], upon which a natural capital management software [200] and other operations and applications, run when a facility [101] is on-grid, or off-grid, and enables users from anywhere in the world to connect to a facility [101] to conduct a variety of activities; a natural capital management software [200], which manages activities associated with natural capital including assessing and trading; a safe [119] to store high value materials, such as precious metals, securely; an HVAC [141] and air purifier [142] to control climate and purify air throughout a facility; connections, systems, and fixtures for power [150], water [145], and a hard-wired network [162]; sensors [156] and meters [157] that measure a variety of variables inside a facility and in or on devices; and other components.

The interior of a facility [101] has an HVAC [141] and air purifier [142] to maintain a suitable environment for facility operators and equipment. A facility [101] has systems, connections, and fixtures for power [150], water [145], and a hard-wired network [162], so that it may operate off-grid when needed or to plug into additional capacity, such as power from a diesel generator, when needed. Sensors [156] and meters [157] measure a variety of variables inside a facility, including climate, power, motion, and device health. This data is logged into a centralized logging, monitoring, and alert system, which is a component of a network, computing, data, communication, and application infrastructure [118] housed in a facility [101].

On the exterior, and to one side of, a facility [101], natural capital may be received and stored under a covered, outside pavilion [126], which has areas designated for receiving [132] and storage [133]. A covered, outside pavilion [126] is created from an overhang [129] from a solar array [113] attached to a shipping container's roof [131]. A receiving [132] area has a certified floor trade scale [143] for bulk natural capital, such as grains and nuts. Facility operators will use portable or hand-held versions of computing devices [137], printers [144], material analysis instruments [116], and other portable, hand-held devices to receive and assess natural capital. A storage [133] area in an outside pavilion [126] is used for temporary storage of natural capital.

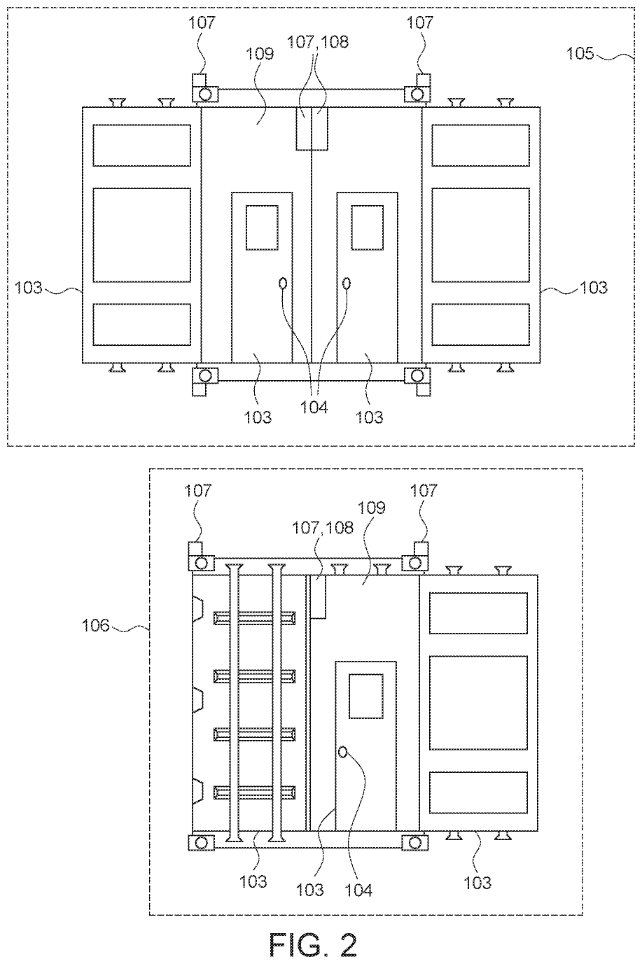

A client or a facility operator will enter a facility [101] through a designated door [103] (represented in FIG. 2), which is controlled by a biometric access control system [104] or by facility operators inside a facility [101]. An entry is covered by a lighting system [107] and video surveillance system [108], both of which may detect motion. Other lighting systems [107] and video surveillance systems [108] are positioned at different locations to ensure the perimeter of a facility [101] is covered entirely to provide visibility and security.

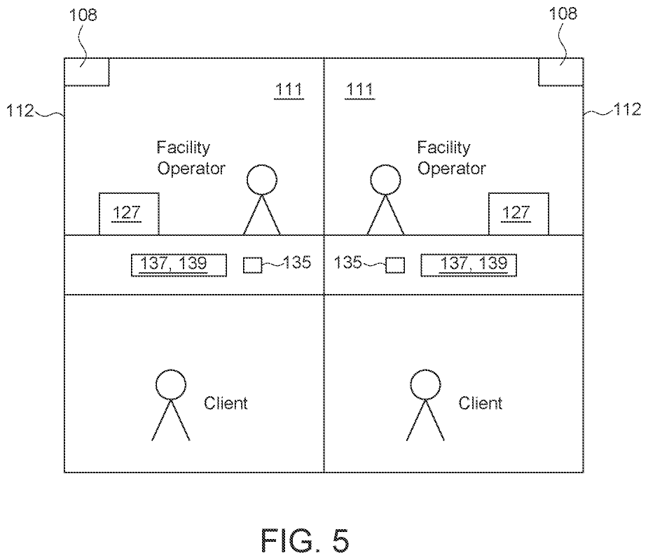

A front entry [105], built at the edge of a shipping container's opening behind external double doors [103] at the front, provides access to a client compartment [110], which is the portion inside of a facility [101] accessible to a client. A client compartment [110] has more than one client cubicle [120], represented in FIG. 5, so that multiple clients may be serviced at one time while allowing each client to operate his or her business separate from another client. A client cubicle [120] is covered by a video surveillance system [108]. In a client cubicle [120], a client participates in transactions at a client commercial counter [139], which is generally outfitted with a touch screen computing device [137]; a multi-function biometric device [135], which is capable of enrolling and verifying a person's face, fingerprint, signature, and other biometric markers; and an input device [139], such as a keyboard.

A rear entry [106], built at the edge of a shipping container's opening behind one external door [103] at the back, leads into a work compartment [111] where facility operators work. A work compartment [111] consists of a facility operator commercial counter [121], precious metal processing counter [122], material analysis counter [123], charging station [124], and rack cabinet [125], safe [119], general work counter [149], check-in and check-out counter [146], and other areas and equipment.

A facility operator transacts with a client at a facility operator commercial counter [121], which is divided from a client cubicle [120] by a structural wall [109] and penetration-resistant window [112]. A facility operator and a client pass documentation, materials, and other items, to one another through a drop box [127] embedded in a window [112]. A facility operator commercial counter [121] includes a touch screen computing device [137]; an accurate, certified trade scale [143]; a printer [144]; a document scanner [166]; input device [139]; bar code reader [153] for reading bar codes on items, such as tags [155]; personal communication device [153], such as a phone, designated for work; and other items. A facility operator will check-in and check-out materials and equipment; process and prepare material for analysis; conduct and complete transactions; and other activities at a facility operator commercial counter [121].

A precious metal processing counter [122] focuses on melting, sampling, pouring ingots of, and quenching ingots of, precious metal. Components of a precious metal processing counter [122] includes: an induction furnace [115], which melts precious metal, and a sink [128], used to quench precious metal after being melted and poured into ingots; a counter area [152] to pour ingots of precious metal; a pin sampler [159] for pulling a sample from melted precious metal for analyzing; security bags [164] in which to place ingots after being processed and at conclusion of a transaction; a fume hood/exhaust system [140] installed above an induction furnace [115] to remove heat generated when an induction furnace [115] is running. A safe [119], meeting UL TL30 standards, stores high value materials, such as precious metals, and other items. It is installed below a counter in a facility [101].

A material analysis counter [123] is where materials are analyzed, using a material analysis instrument [116]. Examples of a material analysis instrument [116] include but are not limited to a Bruker S1 Titan XRF analyzer [134], a microscope, and a lib analyzer. An XRF analyzer, like a Bruker S1 Titan XRF analyzer [134], has been found to be effective at analyzing a variety of materials, including precious metals, other minerals, soil, water, plants, and other materials. An XRF analyzer, like a Bruker S1 Titan XRF analyzer [134], uses calibration files created for a variety of materials and a facility operator may easily switch between them when analyzing different materials, enabling a facility [101] to handle a variety of natural capital with smaller space and fewer equipment requirements.

A data center [117], comprising of the invention's network, computing, data, communication, and application infrastructure [118], is housed in a secure rack cabinet

The architecture [125] supports operation of a local area network (LAN) [162], including an extended wireless network [307] with Internet [160] and cloud connections or without Internet [160] or cloud connections. A local area network [162] includes a cabled, high-speed network for inside a facility [101] and a wifi [162] network, which covers a facility site [163]. Network, server, or data devices [158] may include a server, Internet router [165] enabled with wifi [162], network hub, storage drives, and other devices. Software includes: video surveillance system [108] management; natural capital management software [200]; geographic information system (GIS) server; server operating system; web-based productivity tools; network and device management software; network and device security, including a firewall and anti-virus; syncing and replication tools; web server to support external access through portals [239]; IoT system [233] management; enterprise resource planning system [231]; sample and laboratory management; and other software. A charging station [124] docks and charges handheld, or portable, devices, such as phones or tablets. It is designed to hold a large number of hand-held or portable devices that may be used on a facility site [163] or in the field.

A self-contained facility [100] may have structural, functional, and operational variations. Variations may be based on a variety of factors, including purpose, objectives, context, and business model, relevant for a particular employment, or alternative embodiment, of the invention.

C. Natural Capital Management Software [200]

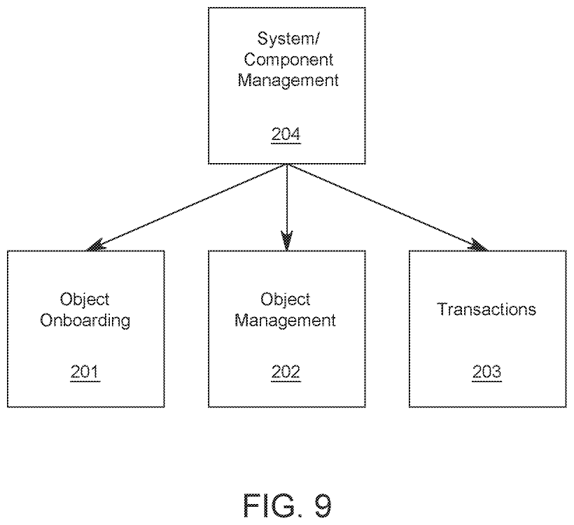

A natural capital management software [200] serves as a front end for a facility operator, and others, with authority to run or operate the invention. Parts of a natural capital management software [200] are available and accessible to stakeholders, such as a client or a partner. Process components of a natural capital management software [200], represented in FIG. 9, include: object onboarding process component [201]; object management process component [202]; transactions process component [203]; system/component management process component [204]; and other components. A natural capital management software [200] is used and operated, in conjunction with other elements, to enable a cohesive, secure, transparent and productive operation.

An object [240] is an artifact, with a record, in a natural capital management software [200] that represents a thing. Objects [240] include a single natural capital, a person, an animal, a transaction, an agreement, an assessment, and other types of things.

An object [240] has a unique record and unique identification number. Actions upon, or including, an object [240] may be directly or indirectly attached to an object [240], such as when a natural capital object [240] is a part of an inventory [243] and any actions taken on a particular inventory [243] impacts a natural capital object [240] that is a member.

An object onboarding process component [201] and a system/component management process component [204] establish the necessary structure and parameters for using an object management process component [202] and a transactions process component [203]. An object onboarding process component [201] enables setting up and activating an object [240] that will be represented, used, acted upon or upon which actions will be dependent in the invention. A system/component management process component [204] manages natural capital, and operations, at an aggregate or entire system level. An object management process component [202] involves a variety of management functions related to a single object [240] or a group of objects [240], such as initiation of and updating records [212], object inventory management [214], and other functions. A transactions process component [203] is a collection of functions, which enable a variety of activities related to trade and leverage of natural capital, natural capital products, and other capital and assets.

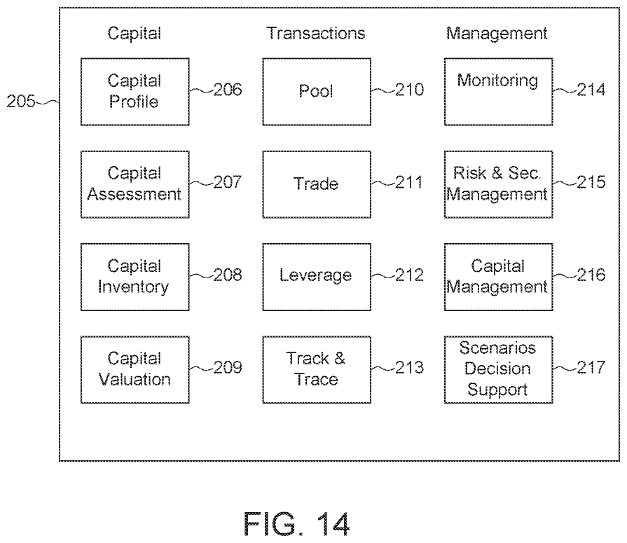

A natural capital management software main screen [205], represented in FIG. 14, is the starting screen for users of the invention to engage and use this component of the invention. The screen [205] is divided into three areas - capital, transactions, and management. Object onboarding is initiated through a capital profile [206] function. A capital profile [206] function is used for onboarding and ongoing activities associated with a natural capital object [240], or other types of objects [240], until an object [240] is archived [220]. From the screen [205], users may initiate and complete any function available, including capital profile [206], capital assessment [207], capital inventory [208], capital valuation [209], pool [210], trade [211], leverage [212], track or trace [213], monitoring [214], risk and security management [215], capital management [216], and scenarios and decision support [217], and other functions.

From a natural capital management software main screen [205], a user will access a capital profile [206] function to onboard, manage, inventory, and valuate a single capital object [240] or group of capital objects [240] within a particular inventory [243]. Users may work on a selected group of inventories [243] at one time when accessing capital assessment [207], capital inventory [208], or capital valuation [209] from a natural capital management software main screen [205].

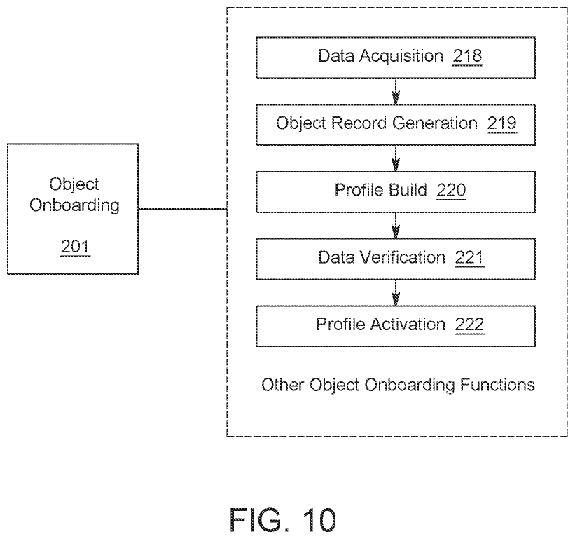

A capital object [240] may be natural capital, an entity, and other types of capital objects [240]. Before a capital object [240] is activated in a natural capital management software [200], a capital object [240] is onboarded and authenticated. The process of completing onboarding serves as a foundation for meeting, or exceeding, compliance, integrity, accountability, and other standards and regulations in relationship to natural capital, people, other types of capital, activities, and transactions. An object onboarding process component [201] consists of functions, represented in FIG. 10, including: data acquisition [218]; object record generation [219]; profile build [220]; data verification [221]; profile activation [222]; and other functions.

Entity types include a person, an organization, and other types of entities. Data acquired on a person may include: copies of official documents, such as government identification, birth records, and others; biometric markers, such as face, fingerprints, iris, and others; and other data. Technology, like a smart card [136], may be issued to allow for both centralized and decentralized verification of a person.

Data acquired on an organization may include corporate registration documents, tax identification number, and other data. An authorized agent for an organization is onboarded, so an authorized agent may perform activities and tasks like buying and selling on behalf of the organization. The tasks associated with onboarding a person apply to onboarding an authorized agent of an organization. Further steps, like determining an official relationship with an organization and span of authority, may be completed when onboarding an authorized agent.

Data acquired on natural capital includes a GPS coordinate location of place of origin, natural capital type, an authorized agent empowered to handle matters related to a particular natural capital, and other data. Other tasks involved in building an initial profile for natural capital are: assessing characteristics and quality factors, which serve as basis for valuation; connecting to a natural capital inventory [243]; generating a valuation; and other tasks. Data acquisition [218] for onboarding objects [240] uses a variety of methods, technologies, and equipment like a drone or rover [306], digital data acquisition forms, and physical investigation [305].

Once a natural capital object [240] is valuated and activated, it becomes an asset managed through a natural capital management software [200] and receives a unique asset code upon activation, which may be tied to an asset token [401] generated by a distributed ledger technologies system [234], to enable transparency, accountability, and traceability of a natural capital asset in a variety of transactions, particularly trading and leveraging. A unique asset code is tied to a capital profile, which provides detailed data, including ownership and activities, for a natural capital object [240]. A natural capital object [240] may only have one asset code.

Once activation occurs, buying, selling, exchanging, leveraging, transferring, and other activities may be performed on a natural capital object [240], within a plurality of parameters, such as user permission and management settings at either an object [240], and component or system level. Activities may occur between any combination of clients, stakeholders, and others anywhere in the world, using the connectivity provided by the invention's network, computing, data, communication, and application infrastructure [118], which connects a facility [101] to data and communication networks around the world.

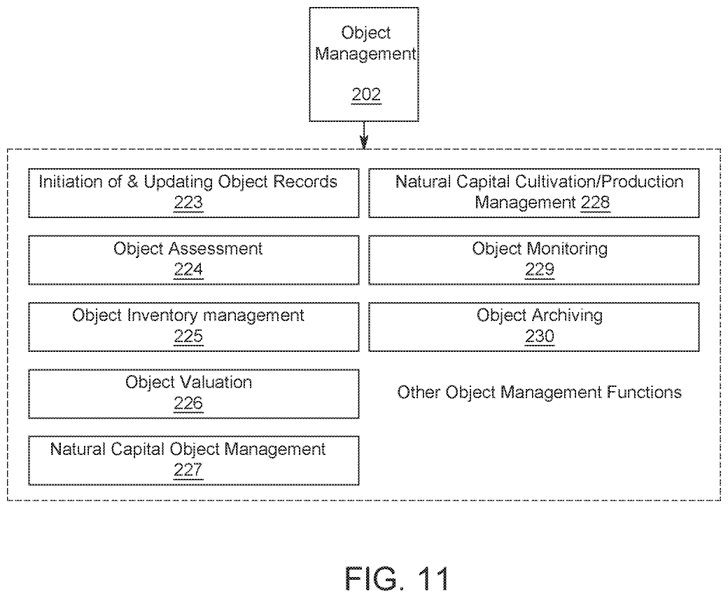

An object management process component [202], represented in FIG. 11, consists of functions, including: initiation of and updating object records [223]; object assessment [224]; object inventory management [225]; object valuation [226]; natural capital object management [227]; natural capital cultivation/production management [228]; object monitoring [229]; object archiving [230]; and other functions. Object management [202] functions are used and operated, in conjunction with other elements, to enable a cohesive, secure, transparent, and productive operation and to manage objects effectively.

Assessment, authentication/provenance, and timely, reliable, accurate data undergird valuation of natural capital, which is a factor in conducting transactions in a natural capital management software [200]. A natural capital object [240], or other object [240], is assessed for quality factors, quantity factors, and other factors. This process is managed in an object assessment [224] function. This function ranges from manually entering in assessment data from an instrument to automatically generating assessment activities and directing instruments and systems to execute the assessment without human intervention, such as with algorithms for monitoring satellite imagery.

An object assessment [224] function establishes standard protocols [238] for assessment of a natural capital type in a natural capital management software [200]. Quality and quantity factor parameters, such as quality grades or units of measure, are established. Standards and protocols [238], such as how to sample a particular type of natural capital and how and when to use a material analysis instrument [116], are established and used in a flow [242] that uses an object assessment [224] function. These, and other, tasks and activities support the generation and capture of reliable, timely, and accurate data, using an object assessment [224] function.

An object valuation [226] function generates a timely valuation of a natural capital object [240] based on the latest, and historical, object assessments, underlying logic [241], and other factors and elements. As natural capital objects [240] are pooled in an object inventory [243], their value is pooled automatically so that valuation for a pool of natural capital objects [240], or assets, is present. Natural capital objects [240], related pools, and valuations of both serve as the basis for transactions, such as trading and leveraging. Parts of valuating [226] an object may be done automatically, such as when a natural capital object [240] is archived [230] and its presence and value is removed automatically.

A natural capital object management protocol [238] may be created for a natural capital object [240]. A natural capital object management protocol [238] is a strategy, guidelines, and management plan, which drive how a natural capital object [240] is sustained and used based on a plurality of parameters, such as whether a natural capital object [240] is a key species and whether a natural capital object [240] is non-renewable. A protocol [238] is administered in a natural capital object management [227] function accessible through a natural capital object's [240] profile [206].

If a natural capital object [240] is intended for cultivation or production, management of cultivation and production is handled by a natural capital cultivation/production management [228] function. This function coordinates and manages activities including: crop management, harvest management, storage management, and other natural capital cultivation/production activities.

Initiation of and updating object records [223] is an ongoing activity. A natural capital profile [206] function is a system element which is the basis for this activity. When a natural capital object [240] is de-activated for a variety of reasons, such as it is fully consumed or has died, it is archived [230] manually or automatically in an object archiving [230] function. Archiving [230] retains everything about a natural capital object [240] but only limited activities may be performed in the future. Under certain conditions, an object [240] may be re-activated.

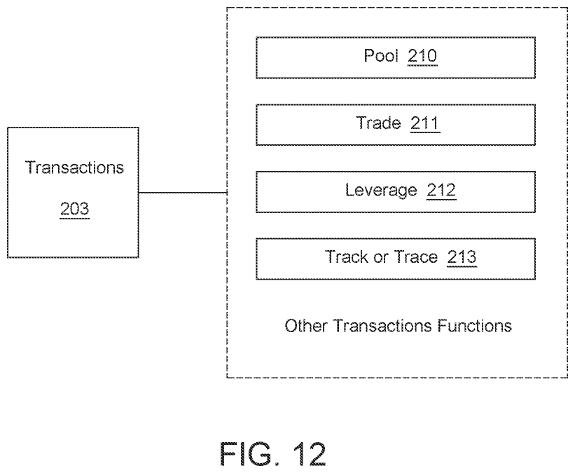

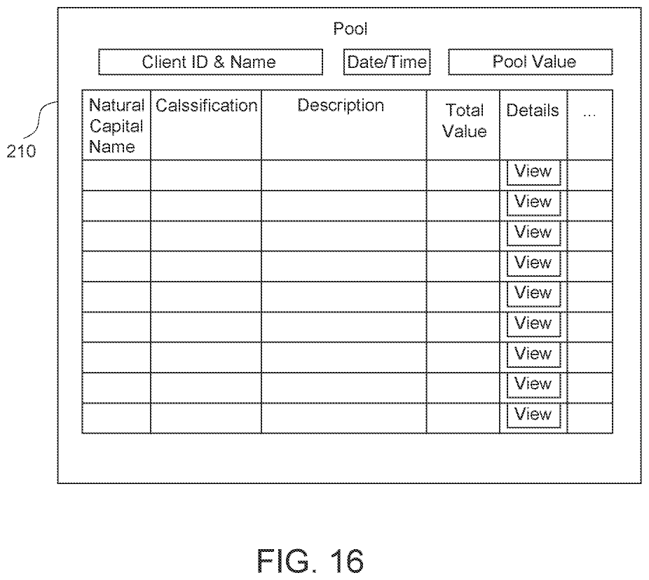

A transactions process component [203], in a natural capital management software [200] consists of functions, represented in FIG. 12, including: pool [210], trade [211], leverage [212], track or trace [213], and other functions. As a natural capital object [240] is activated [222], and valuation [226] recorded, in the invention, a natural capital object [240] becomes an asset that is added to a pool, or inventory [243], of assets attached to its owner, or authorized agent. A pool of assets may be viewed and used, launching from a pool [210] main screen, represented in FIG. 16. An inventory [243] of natural capital objects [240], and other capital objects [240], is the source of a pool [210] of assets in a pool [210] function in a transactions process component [203].

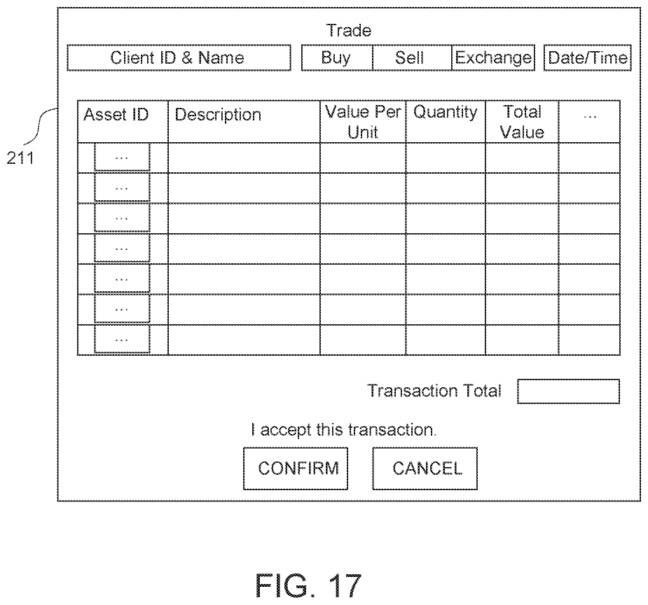

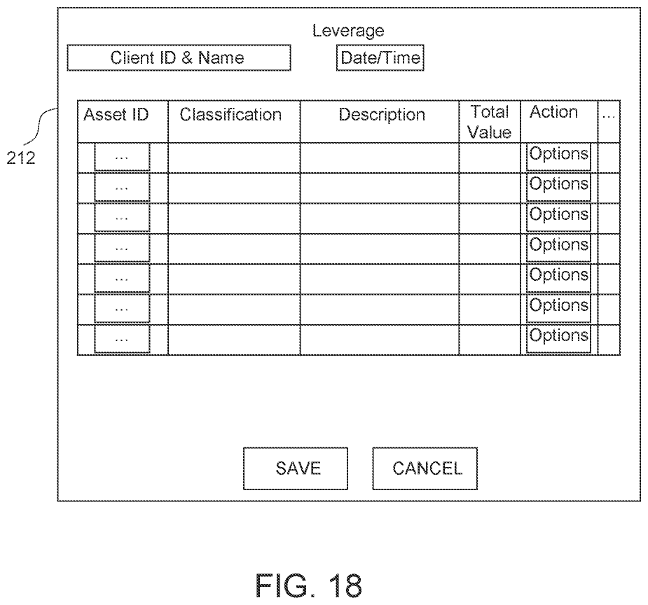

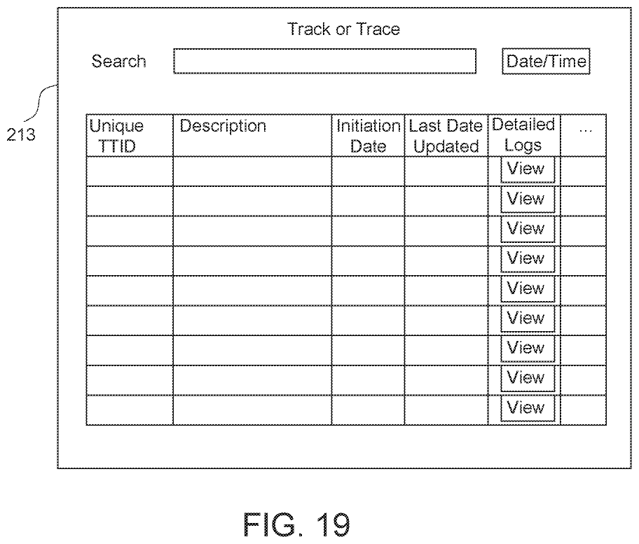

From a pool of assets of natural capital and other asset types, a client may execute a trade, which is buying, selling, or exchanging an asset. A trade is executed on a trade [211] main screen, represented in FIG. 17. A client may execute a leverage, which is using the value or function of an asset to secure or conduct other transactions without having to relinquish ownership. A leverage is executed on a leverage [212] main screen, represented in FIG. 18. Objects [240] in the software [200] may be traced or tracked, using a track or trace [213] function. A track or trace is executed on a track or trace [213] main screen, represented in FIG. 19.

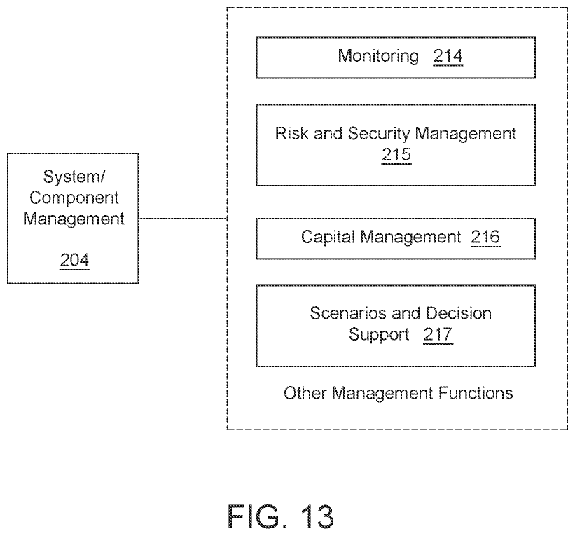

A system/component management process component [204] consists of functions, represented in FIG. 13, including: monitoring [214], risk and security management [215], capital management [216], scenarios and decision support [217], and other functions. A monitoring [214] function supports a variety of activities, including taking data acquired, comparing against set parameters, and sending out alerts or taking certain actions when needed. An action means an event or parameter changes the conditions or state of a particular object [240], such as when a client violates trade rules an alert is sent out and blocks placed so a client may not conduct a trade [211] until issues are resolved. Alerts may be sent in a variety of forms and media, such as text messaging, email, voice call, or screen display. A monitoring [214] function includes logging and reporting sub-functions. Monitoring [214] feeds data into a machine learning and artificial intelligence engine [237] that services a scenarios and decision support [217] function and other system functions.

A risk and security management [215] function supports risk and security management [215] activities, including identifying, monitoring, managing, and mitigating risks. Risk profiles and parameters are set for a variety of objects [240], including events, transactions, and natural capital. Based on a risk profile and parameters, monitoring [214] is established for a particular object [240] or set of objects [240]. A risk and security management [215] function includes tools, such as Monte Carlo simulation, hedging, and permission management, used to manage and mitigate risk. Data from a risk and security management [215] function feeds into a machine learning and artificial intelligence engine [237] that services a scenarios and decision support [217] function and other system functions.

A capital management [216] function supports capital management [216] activities, which include: developing strategies and plans to improve capital management; inventorying and valuating natural capital at a cluster, or at another aggregation, level; setting use and application profiles and parameters for use and management of natural, and other forms of, capital; and other capital management [216] activities. Data from a capital management [216] function is fed into a machine learning and artificial intelligence engine [237] that services a scenarios and decision support [217] function and other system functions.

A scenarios and decision support [217] function uses data from a variety of elements of the invention to provide insights, foresight, and hindsight for informed decision making. It is undergirded with an analytics platform and tools, embedded into an integrated data management system [232]. The analytics platform and tools enable predictive, prescriptive, and other types of analytics. A scenarios and decision support [217] function is enabled to learn and adapt through technologies like a machine learning and artificial intelligence engine [237]. A scenarios and decision support [217] function may use tools and technologies to enable quick, agile, adaptive, and iterative decisions and actions to deal with unknowns, resulting from an environment that is rapid, turbulent, uncertain, and ambiguous.

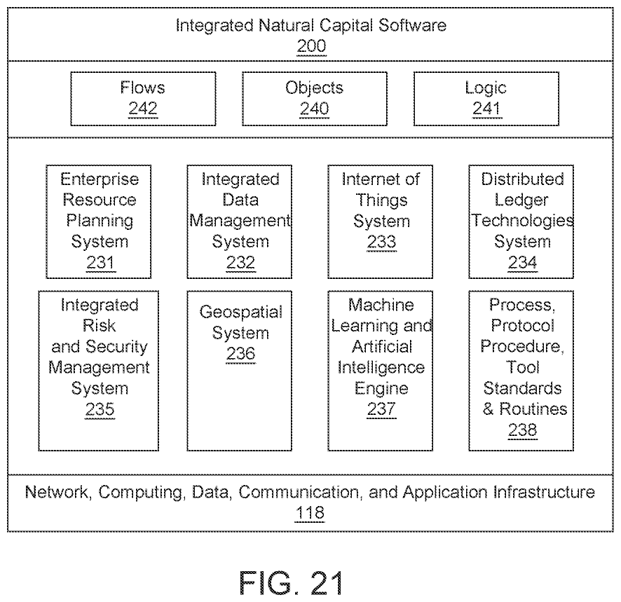

There are sub-components, represented in FIG. 21, that serve as a back engine for, and parts of, a natural capital management software [200], including: flows [242];

objects [240]; logic [241]; network, computing, data, communication, and application infrastructure [118]; enterprise resource planning system [231]; integrated data management system [232]; internet of things system [233]; distributed ledger technologies platform [234]; integrated risk and security management system [235]; geospatial system [236]; machine learning and artificial intelligence engine [237]; and process, procedure, protocol, tool standards and routines [238], and other components.

The OSI Reference Model is a conceptual model for a network, computing, data, communication, and application infrastructure [118] of the invention. The model includes the following layers: physical, data link, network, transport, session, presentation, and application. Horizontal and vertical interoperability is required. The logic model focuses on how the individual elements are integrated and interoperable, such as a network topology. The physical model represents the specific elements of the reference model, such as devices, application, and protocols, that are organized logically in the logic model. A network, computing, data, communication, and application infrastructure [118] serves as an underlying infrastructure for a natural capital management software [200].

An enterprise resource planning system [231] is a software system that supports the management of main business processes in real-time. Business processes covered by an enterprise resource planning system [231] include: accounting, customer support, project management, production, distribution, human capital, product lifecycle management, supply chain and logistics, sales, and other business processes. An enterprise resource planning system enables a variety of activities, including those of production, such as farm or mine site management; managing supply chain of natural capital commodities delivered to markets; and managing a facility [101].

An integrated data management system [232] manages data along its life cycle, which has stages of: 1) acquire, 2) clean, 3) use or re-use, 4) publish, and 5) preserve or destroy. An acquire stage includes creating, capturing, and gathering data. A clean stage includes organizing, filtering, cleaning, and annotating data. A use or re-use stage includes analyzing, modeling, deriving, visualizing data and then deciding and acting based on data. A publishing stage includes sharing, aggregating, and disseminating data. A preserve or destroy stage includes storing, indexing, curating, and destroying data. An integrated data system [232] is used in a variety of activities or flows [242], such as gathering data from drones and satellite; cleaning and processing data; organizing data into a geospatial system [236]; analyze and visualize data for a particular purpose such as crop planning; sharing data with stakeholders; and storing data for ongoing use.

An internet of things system [233] is a network of objects embedded with a variety of things, including sensors, software, and others, to connect devices together, exchange data between the devices, and other physical objects, over a network. An internet of things system [233] is used for a variety of activities or flows [242], such as monitoring health of equipment and soil. Sensors may detect motion, position, environment, mass measurement bio factors, and other variables. The invention enables an internet of things system [233] to operate over an extended wireless network [307], over the Internet, other network architectures and scopes, and in combinations of these networks.

A distributed ledger technologies system [234] is a system consisting of a distributed data structure. Participants in a distributed ledger technologies system [233] write entries into a distributed data structure after validating the entries through consensus, trust agent, or other means of validation. The four elements of a distributed ledger technologies system [233] are action, validation, distributed ledger for recording, and a token showing proof-of-ownership, proof-of-work, and other types of proof. A distributed ledger technologies system [233] is used for a variety of activities, flows [242], and transactions, such as assigning an asset token [401] to a natural capital object [240] after it and its owner or authorized agent have been validated during onboarding; when a trade [211] transaction transfers ownership of a natural capital object [240] to another person or organization, including a natural capital object's [240] asset token [401] being transferred to a new authorized party; and other activities, flows [242], and transactions. An asset token [401] for a natural capital object [240] may serve as the underlying value and artifact for a variety of token-based activities, including escrow, equity and debt securities, private markets, crowdfunding, derivatives, digital currency, and payments. Like the invention, this component may operate over networks around the world synchronously or asynchronously.

An integrated risk and security management system [235] manages risk and security protocols and procedures [238] for objects, activities, events, and other elements of the invention. An integrated risk and security management system [235] enables a risk and security management [215] function, which executes or supports execution of activities, including: identifying issues and setting context; assessing key risk areas; measuring likelihood and impact of risks; ranking risks; setting desired results; developing options; selecting a strategy and setting parameters in a risk and security management [215] function; evaluating data from logging, monitoring, and alert systems and making adjustments; and other risk and security management [215] related activities. Risk types covered include people, operations, systems and technology, environment, processes, events, and other risk types. An integrated risk and security management system [235] covers elements of the invention and a context in which it operates. It is activated when a trigger, such as a new entity object [240] being activated or an object, or other factor, is no longer valid.

A geospatial system [236] manages spatial data. It is embedded with an integrated data management system [232]. It supports spatial data management throughout the lifecycle of spatial data, using a geographic information system (GIS). A geospatial system [236] supports and enables location intelligence, which supports strategy, planning, development, and implementation across spheres, including business, social, and government, and across a variety of sectors, such as agriculture, mining, urban planning, integrated development, consumer markets, health, and safety. A geospatial system [236] supports a variety of activities, such as mapping a natural capital object [240] like a parcel of land and attaching relevant data for stakeholders increasing transparency and traceability.

An artificial intelligence and machine learning engine [237] is one that simulates human intention, intelligence, and adaptability in performing tasks and making decisions and learns by experience with or without human intervention. Artificial intelligence comes in different forms: analytic, such as conducting risk assessments; functional, such as performing repetitive tasks; interactive, such as chatbots; text, such as text recognition and speech-to-text conversion; visual, such as augmented reality; and other forms. As machine learning occurs, it enables a variety of automated or assisted activities, including identification of natural capital objects [240], fraud and risk detection, security intelligence, and alternative scenario development. An artificial intelligence and machine learning engine [237] supports management functions of a natural capital management software [200], including monitoring [214], risk and security management [215], capital management [216], and scenarios and decision support [217]. An underlying network, computing, data, communication, and application architecture [118] supports this component.

A process, procedure, protocol, tool standards and routines [238] component is an architecture and guides management of the invention's flows [242], actions on objects [240], and logic [241], such as when a natural capital object [240] is assessed. This component enables a consistent and compliant operation. Process, procedure, protocol, tool standards and routines [238] use a variety of standards, such as business rules markup language (BRML), unified modeling language (UML), and extended markup language (XML), and open source tools to generate structure of interactions between flows [242], objects [240], and logic [241].

A natural capital management software [200] may have structural, functional, and operational variations. Structures, functions, operations and other items of a natural capital management software [200] are added, adapted, or deleted as needed based on a variety of factors, including purpose, objectives, context, and business model, relevant for a particular employment, or alternative embodiment, of the invention.

D. Field Operations [300]

The functions and capabilities of a facility [101] may be extended to the field by adding field operations [300] to an existing facility [101] operation. Field operations [300] are activities performed in the field on a field site [301] a facility [101] has responsibility for monitoring, managing, coordinating, cultivating, producing, and other activities related to natural capital. Field operations [300] at a field site [301] enables a facility [101] to access and use direct data, in addition to access and use of indirect data, such as satellite images, to authenticate and certify integrity of factors associated with extracted or harvested natural capital from a particular location and monitor and manage natural capital. The resulting data is managed in a natural capital management software [200]. Field operations [300] may include a vehicle-based facility [101], such as a van, which may be used to monitor and verify natural capital at different points along a supply chain.

Field operations [300] may include mapping, monitoring, and managing a field site [301]; testing and implementing solutions; onboarding capital, including natural capital and entities; receiving and trading natural capital; analyzing and assessing in-ground and above-ground natural capital, as well as harvested or extracted natural capital; providing support and extension services, including training, inputs, and mentoring, to stakeholders who are involved with a field site [301]; and other activities that may also occur, or do not occur, at a facility [101]. A field operator combines activities into projects. Field projects may be a few hours, several days or several weeks and near or hundreds of kilometers from a facility [101]. Field projects vary project by project due to many factors, which requires agile and adaptive use of elements of the invention.

Field operations [300], and facility [101] operations, are managed in a natural capital management software [200]. In addition to equipment and tools used from a facility [101], field operations [301] may use: drones or rovers [306]; portable or modular kits [304]; measurement or assessment devices [310]; personal communication devices [153], such as radios and phones; precious metal devices or tools [302]; sensors [156] or meters [157]; physical investigation or sampling kits [305]; cameras (still or video) [309]; robotics, automation, or remote control [303]; and other equipment or tools. Equipment and tools used in field operations [300] compared to those used at a facility [101] may vary in form, such as being hand-held or portable, to enable easier movement in the field.

Robotics, automation, or remote control [303] increase capacity of the invention by freeing a field operator or a facility operator from constraints, such as time and physical obstacles. Robotics, automation, or remote control [303] are improved on an ongoing basis by use of a machine learning and artificial intelligence engine [237] and other technologies.

A portable or modular kit [303] may be a variation of the invention in modular, miniaturized, or other embodiments, which may have a smaller scope of function and form than a facility [101]. A portable or modular kit [304] may be combined with a physical investigation or sampling kit [305] and camera (still or video) [309] to conduct a variety of activities, such as receiving [142] and trading [148] natural capital, on a facility site [163], increasing its capacity, and on a field site [301].

A drone or rover [306] increases the amount of higher fidelity data acquired and distance that a field operator may cover when performing mapping, monitoring, and other activities related to natural capital. A variety of cultivation and production equipment [308] improves the production of natural capital products and commodities. An extended wireless network [307] functions as communication and network infrastructure that ties elements and activities together on a field site [201] and between a field site [301] and a facility [101]. An extended wireless network [307] enables continuous activities, such as automatic monitoring and data acquisition using a sensor [156] or meter [157] even when a field operator is not present. An extended wireless network [307] may work with satellite, Internet [161], and other technologies to share, distribute, and exchange data around the world as needed.

Data acquired whether in the field or at a facility [101], from a variety of manual and automatic means, such as from a sensor [156] or a meter [157], is feed into different components of a natural capital management software [200] to inform decisions and guide either manual or automatic actions that are managed or controlled in an object management process component [202]. These management activities may alter parameters for other activities involving natural capital, including valuation [226], trading [211], leveraging [212], and other activities.

Field operations [300] may have structural, functional, and operational variations. Structures, functions, operations and other items of field operations [300] are added, adapted, or deleted as needed based on a variety of factors, including purpose, objectives, context, and business model, relevant for a particular employment, or alternative embodiment, of the invention.

E. Globally Available Capital Transactions Platform [400]

A facility [101] serves as a globally available capital transactions platform [400] for natural capital, and other capital, managed by a facility [101]. A facility's [101] infrastructure enables global access, through a portal [239], to features and functions of a natural capital management software [200]; and therefore, to natural capital assets managed by the software [200]. Any authenticated and authorized entity may access and use parts of a natural capital management software [200], particularly a transactions process component [203].

Global users may buy, exchange, or sell natural capital, as well as leverage natural capital for further transactions. In-ground, above-ground, harvested or extracted natural capital may be included in transactions, such as a transaction simultaneously using the value of in-ground or above-ground assets on a particular parcel of land to finance annual crop production on the same parcel while arranging an off-take agreement for natural capital product when it is harvested.

A distributed ledger technologies system [234], particularly an asset token [401], a cryptocurrency [402], or a smart contract [403], enable the use of, or further management of, a natural capital asset managed by a natural capital management software [200] in a variety of use cases [404] including: digital currency, cryptocurrency, or physical currency; contracts; securities; record keeping, and other use cases.

Digital currency, cryptocurrency, or physical currency use cases [404] include remittances, global payments, microfinance, ecommerce, p2p lending, and other digital currency, cryptocurrency, or physical currency use cases [404]. Contract use cases [404] include notarization, digital rights, escrow, trusts, offtake agreements, preservation agreements, and other contract use cases [404].

Securities use cases [404] include debt, equity, private markets, crowdfunding, derivatives, and other securities use cases [404]. Recordkeeping use cases [404] include intellectual property, voting, ownership, title management, and other recordkeeping use cases [404].

Any type of token may be generated on any type of object [240] activated or operating through the invention for use in other activities, transactions, or use cases. Other platforms, technologies, or tools may be used to enable a globally available capital transactions platform [400].

A globally available capital transactions platform [400] may have structural, functional, and operational variations. Structures, functions, operations and other items of a globally available capital transactions platform [400] are added, adapted, or deleted as needed based on a variety of factors, including purpose, objectives, context, and business model, relevant for a particular employment, or alternative embodiment, of the invention.

F. Transaction Flow [500]

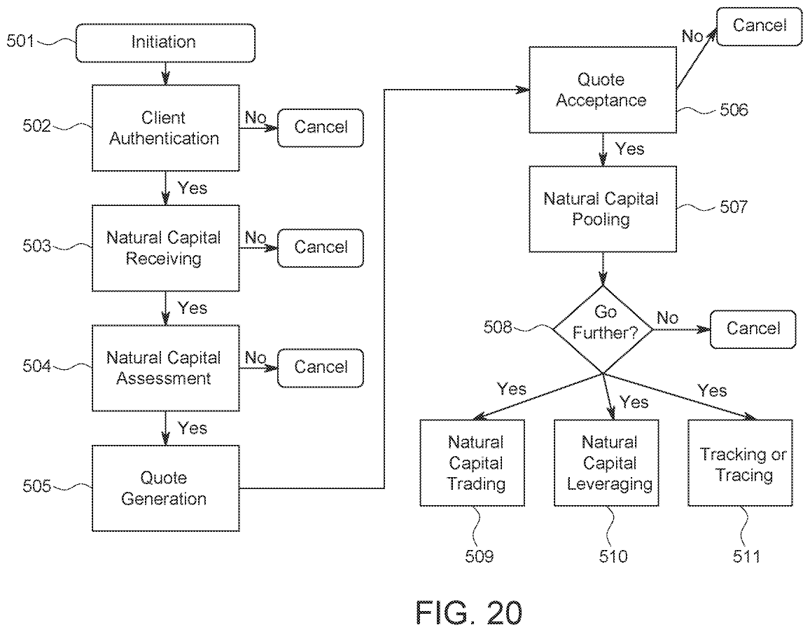

There are a variety of initial activities, such as data acquisition, data input, measurement, and assessment, when a natural capital object [240], or other objects [240], is onboarded [201]. These, and other activities, occur on an ongoing basis in a variety of combinations and flows [242], creating a variety of objects [240] in a natural capital management software [200]. These activities use an object onboarding process component [201], an object management process component [202], a transactions process component [203], and a system/component management process component [204] in a variety of combinations. These activities create a history, which flows into an activity to inform and manage its execution and flows out as a new historical item when an activity is generated. A transaction flow [500], represented in FIG. 20, is a combination of activities, logic [241], components, and tasks that occur in a natural capital management software [200].

A transaction flow [500] steps include: initiation [501]; client authentication [502]; natural capital receiving [503]; natural capital assessment [504]; quote generation [505]; quote acceptance [506]; natural capital pooling [507]; go further decision [508]; natural capital trading [509]; natural capital leveraging [510] and other actions or options. A transaction flow [500] may be adapted for a particular context, or other factors, such as a transaction history of a particular client. A transaction flow [500] operates in conjunction with other elements to enable a transparent, seamless, and traceable transaction. A transaction may occur at a field site [301], in a facility [101], or globally.

A user, such as a client, an operator, or others, may initiate a transaction flow [500]. Initiation [501] may involve preliminary discussion, preliminary review of documentation, preliminary natural capital inspection and assessment, and preparation to organize a seamless transaction. Once a transaction is initiated [501], a client is authenticated [502]. If a client does not pass authentication [502], a transaction is cancelled.

Upon successful authentication [502], natural capital may be received [503]. Receiving [503] includes visual, touch, smell, and other means of physical inspection of natural capital; collecting necessary documentation; weighing and measuring dimensions of natural capital; sampling natural capital; tagging natural capital and scanning tag into a natural capital management software [200], using a bar code reader [154]; placing natural capital in a secure, holding area [133] while transaction is completed or it is cancelled; and other receiving [503] activities. Natural capital receiving [503] may be cancelled by a user for a variety of reasons: natural capital does not pass visual inspection, documentation is not complete; client decides to not continue transaction; and other reasons.

If natural capital receiving [503] is successful, natural capital is assessed [504] by an operator, according to standards and protocols [238] specific to a particular natural capital type outlined and managed in a natural capital management software [200]. Natural capital assessment [504] uses material analysis instruments [116], such as an XRF analyzer and others. If assessment [504] of natural capital is not successful, a transaction is cancelled.

Upon successful assessment of natural capital [504], quote generation [505] may occur. A quote is a form that transparently displays a value offer for natural capital received [503] in that instance and moment of time. A quote is based on the value of natural capital, quantity or volume of natural capital, value per unit of measure, and other factors. Value per unit of measure is generated based on prices that are calculated from input factors like real-time market prices, premiums given on certain natural capital types, contractual agreements, and other input factors. A quote is displayed to a client through a natural capital management software [200] on a variety of computing devices [137] and other devices. After reviewing a quote, a client either accepts or not accepts [506] a quote. If a client does not accept [506] a quote, a transaction is cancelled, natural capital is returned to client, and other actions may be taken. When a client accepts [506] a quote, a variety of activities or tasks occur including: value of the natural capital is transferred [507] automatically to a pool of assets held by a client; a transaction is closed out in system; client receives a transaction receipt; logistics steps are taken to move natural capital to appropriate storage; and other actions may be taken.

A client may choose to continue [508] to trade [509] natural capital, leverage [510] natural capital, or perform other transactions. If a client chooses to initiate natural capital trading [509] or natural capital leveraging [510], a new transaction is initiated. If a client does not choose to initiate additional transactions immediately, a client may use his or her pool of assets to do so in the future. Any authenticated and authorized user may access a globally available capital transactions platform [400] to conduct a pool [210], trade [211], leverage [212], trace or track [213], or other transactions on natural capital managed in a natural capital management software [200].

Throughout and after a transaction flow [500], users receive notifications of events, such as successful completion of an activity, transaction cancellation, physical movement of natural capital, and other events. Notifications are delivered through a variety of mediums, including email, text messaging, screen displaying, voice call, and other mediums. Users may access historical transaction details in an account in a natural capital management software [200].

A transaction flow [500] may have structural, functional, and operational variations. Structures, functions, operations and other items of a transaction flow [500] are added, adapted, or deleted as needed based on a variety of factors, including purpose, objectives, context, and business model, relevant for a particular employment of the invention.

F. Connections of Main Elements and Sub-Elements of Invention

A self-contained facility [100], a natural capital management software [200], and a method to procure, assess, and trade natural capital such as a transaction flow [500], tie together main elements and sub-elements of the invention. Further, the OSI reference model serves as a conceptual model to logically organize different types of elements, and components, associated with a natural capital management software [200]. A physical layer of the OSI reference model connects the various physical elements of the self-contained facility [100] to a natural capital management software [200]. The connections are enabled to produce a cohesive, integrated, and interoperable operation.

G. Alternative Embodiments of Invention

The invention as a whole, or in part, may be embodied in a variety of embodiments. The invention may be altered in a variety of ways, such as structural change, functional change, operational change, miniaturization, virtualization, full remote control, automation, robotics, self-learning, modularization, material change, device change, equipment or instrument change, and other alterations to create alternative embodiments. An example alternative embodiment may be a portable or modular kit [304] that may be carried by people when there is a requirement of increased mobility more frequently, over greater space, or over tougher terrain. Another example embodiment is vehicle/transport equipment, such as van, pickup truck, or roller carts. Other alternative embodiments may derive based on a variety of factors, including contextual factors, purpose, objectives, or other factors. The invention may be embodied in a variety of embodiments simultaneously operating in a particular employment of the invention.

H. Operation of Preferred Embodiment

A facility [101], field operations [300], and natural capital transactions platform

operate based on parameters defined at a system or component level in a natural capital management software [200]. This enables a secure, risk mitigating, transparent, and productive operation.

First, a field site [301], including subsets of natural capital such as trees and minerals, are onboarded [201], assessed [224], and valuated [226]. Onboarding [201] includes natural capital and entities associated with a field site [301], including owner, workers, producers, and others. A field operator creates a project in a natural capital management software [200] to coordinate and schedule tasks to onboard, assess, and valuate a variety of natural capital and entities associated with a field site [301]. Over a period of time, a field operator will complete the project, which includes data acquisition [218]; object record generation [219]; profile build [220]; data verification [221]; profile activation [222]; object assessment [224]; object inventory creation and addition of capital objects [225]; and object valuation [226].

Field operations [300] provides authentication, provenance, tracking, monitoring, and management of natural capital at a particular location and natural capital commodities or products extracted or harvested from a particular location. A client, or others, may conduct activities or transactions based on the outputs from field operations [300].

A field operator may receive extracted or harvested natural capital, such as precious metals or agricultural commodities, at a field site [301]. A field operator and a client initiate [501] a transaction [500]. Once initiation [501] is concluded, a field operator will perform client authentication [502], using a hand-held, multifunction biometric device [135] and a natural capital management software [200] loaded on a computing device [137]. A client will provide his or her smart card [136] for decentralized authentication of his or her identity. Triggers, events, activities, objects created or used, and results of client authentication [502] are logged and monitored in a natural capital management software [200]. Any variants outside of parameters will result in alerts and actions being taken, such as blocking a transaction [500]. If a client is authenticated [502], a transaction [500] may proceed otherwise a transaction [500] is cancelled.

Based on a natural capital type of a harvested or extracted natural capital, a field operator pulls up an appropriate protocol and procedure [238] for receiving [503] a particular type of natural capital and initiates a natural capital receiving [503] routine [238] in a natural capital management software [200]. A specific routine [238] for a particular natural capital type being received [503] walks a field operator through a protocol and procedure [238]. A routine [238] generally involves both manual and automated tasks with system checks provided throughout a routine [238]. A receiving [503] routine [238] involves physical inspection, including visual, smelling, touching, and other physical inspection techniques; weighing and measuring natural capital being received [503]; sampling natural capital and labeling the sample; creating records for received natural capital in a natural capital management software [200]; and other natural capital receiving [503]activities or tasks. Triggers, events, activities, objects created or used, and results of a natural capital receiving [503] routine [238] are logged and monitored in a natural capital management software [200]. Any variants outside of parameters will result in alerts and actions being taken, such as blocking a transaction [500] from going further. If harvested or extracted natural capital is received [503] successfully, a transaction [500] may proceed; otherwise a transaction [500] is cancelled.

Once natural capital receiving [503] is finished, a field operator initiates a natural capital assessment [504] routine [238] in a natural capital management software [200]. A specific routine [238] for a particular natural capital type being assessed walks a field operator through a protocol and procedure [238]. A field operator assesses [504] natural capital samples with: material analysis instruments [116], such as a hand-held Bruker S1 Titan XRF analyzer [134]; a specific assessment protocol and procedure [238] for a particular natural capital type, which may be manual or automated; and other natural capital assessment [504] methods, tools, or equipment. The results of a natural capital assessment [504] are recorded in an object assessment function [224] in a natural capital management software [200]. A natural capital assessment [504] routine [238] may also include packaging and tagging of natural capital and samples, and generating a temporary receiving receipt for client. From this point on, natural capital may be tracked and traced [511]. Triggers, events, activities, objects created or used, and results of natural capital assessment [504] routine [238] are logged and monitored in a natural capital management software [200]. Any variants outside of parameters will result in alerts and actions being taken, such as blocking a transaction [500] from going further. If a natural capital assessment [504] routine [238] completes successfully, a transaction [500] may proceed; otherwise, a transaction [500] is cancelled.

Once natural capital has been assessed [504] at a field site [301], a field operator generates [505] a quote for the value of a particular natural capital that has been received [503] and assessed [504], using a computing device [137] and a quote generation [505] routine [238] in a natural capital management software [200]. A quote is generated based on quantity factors and quality factors measured and assessed in natural capital receiving [503] and natural capital assessment [504] steps; contract terms, such as discounts; current market prices pulled down in real-time over a global network or prices set as a parameter in a natural capital management software [200]; and other factors which serve as inputs into a quote generation [505] logic [241] that is used to produce a quote. Upon successful completion of a logic [241] sequence, a quote is displayed on a field operator's computing device [137]. A field operator may send a copy of a quote to a client for review via email or a field operator may show quote displayed on a computing device [137] to a client. Triggers, events, activities, objects created or used, and results of a quote generation [504] routine [238] are logged and monitored in a natural capital management software [200]. Any variants outside of parameters will result in alerts and actions being taken, such as blocking a transaction [500] from going further. If a quote generation [504] routine [238] completes successfully, a transaction [500] may proceed; otherwise, a transaction [500] is cancelled.

After reviewing a quote, a client accepts [506] or declines a quote, using a computing device [137] and an input device [139], on a quote screen in a natural capital management software [200]. A client provides a signature and clicks an ‘accept’ button to accept [506] a quote. A field operator acknowledges that a quote has been accepted [505] by providing a signature and clicking a ‘confirm’ button on a separate screen. A natural capital management software [200] automatically sends a quote receipt to a client. Triggers, events, activities, objects created or used, and results of a quote acceptance [506] routine [238 ] are logged and monitored in a natural capital management software [200]. Any variants outside of parameters will result in alerts and actions being taken, such as blocking a transaction [500] from going further. If a quote acceptance [506] routine [238] completes successfully, a transaction [500] may proceed; otherwise, a transaction [500] is cancelled.

At this stage, natural capital becomes a managed asset in the invention and a natural capital pooling [506] routine [238] automatically adds the value of natural capital attached to an accepted [505] quote to a pool, or inventory [243], created for a client when a client was onboarded [201]. The invention also runs risk and security management [215] actions, such as setting up a risk profile based on natural capital type and hedging against commodity price risk, in a natural capital management software [200].

A client maintains ownership of natural capital assets until a client completes a trade [211] transaction. A natural capital management software [200] generates a receipt for client instantaneously when pooling [507] completes. A confirmation notification is sent by a natural capital management software [200] to both a client and a field operator. Triggers, events, activities, objects created or used, and results of a natural capital pooling [507] routine [238] are logged and monitored in a natural capital management software [200]. Any variants outside of parameters will result in alerts and actions being taken, such as blocking a transaction [500] from going further. If a natural capital pooling [507] routine completes successfully, a transaction [500] is concluded.

If a client indicated that a natural capital transaction includes trade [211] or leverage [212] at initiation [501], a new transaction [500] for a trade [509] or leverage [510] will be automatically initiated.

A client may initiate a transaction [500] at a facility [101], represented in FIG. 4. Detailed routines within a transaction flow [500], represented in FIG. 20, at a facility [101] may differ from those used at a field site [301].

If a client has bulk natural capital, like agricultural commodities, bulk natural capital is received [502] in an outside pavilion [126], represented in FIG. 4. After bulk natural capital is tagged, samples labeled, and data recorded in a natural capital management software [200], parts of natural capital assessment [504], particularly material analysis and completing a transaction, occur inside a facility [101]. A facility [101] has a hard-wired local area network [162] over which facility [101] operations are conducted, providing faster speeds and better security than wifi [161].

A client approaches a front entry [105] of a shipping container, represented in FIG. 1, FIG. 2, and FIG. 4. A client gains access to a client cubicle [120] in a client compartment [110] of a facility [101] by swiping a smart card [136] containing client's biometric details and providing a finger or face to verify a client's identity, using an access control system [104] at a door [103] leading into a client cubicle [120]. If there is a problem or a client is not yet onboarded [201], a facility operator may open a door [103] remotely from inside a work compartment [111] in a facility [101]. A facility operator may see and speak to a client at a front entry [105], using a video surveillance system [108]. A facility operator is notified of a client's presence through triggers when motion is detected, prompting facility operator to check video surveillance system [108] feed on a computing device [137] in a work compartment [111]. As a client moves around or conducts activities in a client cubicle [120], a video surveillance system [108] records activity.

A client may not be onboarded [201] yet if a client has not participated in activities tied to field operations [300] and is visiting a facility [101] for the first time. If a client is not onboarded [201], a facility operator onboards [201] a client, using a routine in a natural capital management software [200]. A client will enroll his or her biometric details, including face, fingerprint, and signature, using a multifunction biometric device [135] at a client commercial counter [138], and provide a facility operator necessary documentation, such as government identification, and details. A facility operator and a client pass materials and documentation, using a drop box [127] embedded in a window [112], separating a client cubicle [120] from a work compartment [111] in a facility [101]. A client enters in details, using a touch screen computing device [137] and input device [139], at a client commercial counter [138]. If an onboarding process (including [218], [219], [220], [221], and [222] represented in FIG. 10) is successful, a client may proceed with a transaction process [203]. If an onboarding process [201] is not successful, a client may not initiate a transaction process [203].

If a location is not onboarded in a natural capital management software [200], a transaction [500] is cancelled as natural capital is only accepted from registered and approved sites. If a client is new, there are limits on amount of natural capital of any kind that may be transacted upon. If client accepts these limits, a transaction may be initiated.

If a client is authenticated, has precious metals, but has not initiated a transaction flow [500] elsewhere, a client and facility operator initiate a transaction process [203], using a transaction flow [500] with underlying routines [238] and logic [241] in a natural capital management software [200] while present in a facility [101]. A client passes precious metals, such as gold, to a facility operator through a drop box [127] embedded in a window between a client cubicle [120] and work compartment [111]. Within sight of a client looking through a window [112] into a work compartment [111] and the display on a touch screen computing device [137], a facility operator will inspect, prepare, process, analyze, pour ingots of, quench, and finalize a transaction for precious metals.

A facility operator initiates a precious metal transaction flow [500] for a particular type of precious metal, such as gold, in a natural capital management software [200]. A precious metal receiving [502] routine automatically initiates, according to the type of precious metal, prompting a facility operator to weigh precious metal, using a trade scale [143], at a facility operator commercial counter [121] in a work compartment [111]. At the same time, a client is prompted to enter required transaction details, such as whether or not a client wants to pool [210], trade [211], or leverage [212] precious metals, on a touch screen computing device [137] at a client commercial counter [138] in a client cubicle [120].

A video surveillance system [108] placed in at least two locations, such as on a ceiling, in a work compartment [111] records all activity and movement of facility operators, enabling a transparent transaction [500]. Triggers, events, activities, objects created or used, and results of any precious metal routine [238] are logged and monitored in a natural capital management software [200]. Any variants outside of parameters will result in alerts and actions being taken, such as blocking a transaction [500] from going further.

A facility operator is prompted by a precious metal processing routine [238] in a natural capital management software [200] to process precious metal after a client completes entering details; precious metals are weighed; and a facility operator reviews and confirms details in a natural capital management software [200] at a computing device [137], using a display device [151] and input device [139], at a facility operator commercial counter [121]; labels with bar codes and other information for processing are generated by a natural capital management software [200] and a print out completes at a printer [144].

Next, a facility operator moves with precious metal and labels to a precious metal processing counter [122]. A facility operator places a label on ingot processing [152] area, indicating for which transaction precious metals are being processed, and turns on an induction furnace [115] and fume hood/exhaust system [140]. While waiting for an induction furnace [115] to heat up, a facility operator places precious metal into a crucible, which will be placed in an induction furnace [115]. After an induction furnace [115] heats up, a crucible with precious metals is placed in an induction furnace [115] through a top opening. Once precious metal is melted, a pin sampler [159] is placed in the melted precious metal in the crucible and drawn out to generate a sample. The sample is placed in a dish with a label linked to a particular precious metal transaction [500] in progress.

A facility operator passes a sample of precious metal to another facility operator at a material analysis counter [123]. A new facility operator scans a bar code for a sample of precious metals into a natural capital management software [200], using a bar code reader [154], which initiates a precious metal assessment [504] routine [238]. A facility operator completes a precious metal assessment [504] routine [238], according to a standard protocol and procedure [238] for a particular type of precious metal. A precious metal routine [238], in a natural capital management software [200], walks a facility operator through a protocol and procedure [238], which involves manual and automated tasks. After a sample of precious metal has been analyzed by a Bruker S1 Titan XRF analyzer [134], the results are automatically loaded into a natural capital management software [200]. A facility operator completing a transaction [500] with a client is notified on a personal communication device [153], such as a phone, and on a display device [151] at a facility operator commercial counter [121]. A client is notified a sample assessment [504] is complete on a touch screen computing device [137] at a client commercial counter [138].

A facility operator at a material analysis counter [123] passes sample of precious metal back to a facility operator handling a transaction [500]. A facility operator places a sample of precious metal back into a crucible of precious metal in an induction furnace [115]. A facility operator generates a quote [505] for a client. While client is reviewing a quote, a facility operator pours precious metal from a crucible into an ingot at an ingot processing [152] area on a precious metal processing counter [122]. When the precious metal solidifies after cooling enough, a facility operator drops it into a sink [128] at a precious metal processing counter [122] to quench an ingot.

When an ingot is quenched, a facility operator cleans up precious metal processing counter [122]; turns off induction furnace [115] and fume hood/exhaust system [140]; and moves with precious metal ingot back to a facility operator commercial counter [121] to complete a transaction [500]. If a client accepts [506] a quote, a facility operator reviews quote, signs electronically using touch screen display device [151],and confirms by clicking a ‘confirm’ button. A natural capital management software [200] will automatically transfer value of precious metal received [503] and transfer it to a client's pool of assets in a natural capital management software [200].

A facility operator is prompted by a natural capital material processing routine [238] to place a precious metal ingot into a security bag [164]. A facility operator places ingot into a security bag [164]; scans bar code for security bag into software [200], using a bar code reader [154]; and places ingot in a UL rated TL30 safe [119]. An ingot remains in a safe [119] until transport security arrives for a pick-up. While a facility operator is finalizing a transaction [500], a client may continue to perform other activities or transactions, such as pool [210], trade [211], leverage [212], or track or trace [213].

Once a client and natural capital are onboarded [201], transactions [500] may occur when natural capital is received or at another time. Transactions involving changes in the state of value, such as trading, leveraging, re-valuating, removing, transferring, and others, require facility operator involvement, which requires synchronous or asynchronous interaction between a client and facility operator. Users may initiate transactions and provide necessary details at anytime from anywhere. A facility operator will then review details and activate a transaction process [203] and engage with a client. Other tasks and activities, such as a client viewing his or her pool of assets, may be done anytime anywhere without interacting with a facility operator. A facility [101] serves as a multi-sided platform [400] to conduct natural capital transactions [203], so a global user conducts transactions with a client who owns, or is authorized to manage, natural capital assets in a natural capital management software [200] through a portal [239] over the Internet [161].

A client initiates a trade [211] transaction when he or she wants to buy or exchange natural capital assets that he or she owns and that resides in a client's pool in a natural capital management software [200]. If a facility [101] is a buyer, a facility operator and client initiate a trade [211] transaction at a field site [301] or in a facility [101]. After authentication [502], a client completes a trade [211] transaction request, indicating what natural capital and how much of it a client wants to sell, on a computing device [137]. A client uses a computing device [137], an input device [139] and a natural capital management software [200] to complete a trade transaction request. A facility operator reviews a trade [211] transaction request and generates a trade [211] transaction, which displays on display devices [151] for a facility operator and a client. A client accepts a trade [211] transaction on a trade [211] main screen, represented in FIG. 17. A client electronically signs, using a biometric device, on a trade [211] transaction on a separate screen. A facility operator reviews final trade [211] transaction details and concludes a trade [211] transaction. A natural capital management software [200] sends payment to a client using payment details in the system and generates receipts for trade [211] transaction and payment. Receipts are sent to a client via email. A facility operator or field operator may provide a print out of receipts, using a printer [144], to a client.

A leverage [213] transaction is unique, consisting of a variety of factors, including scope, methods, agreements, and other items. A client may allocate his or her natural capital assets to actions which make use of natural capital assets while a client maintains ownership. A facility [101] company serves as a trustee in these transactions concerning natural capital, providing a transparent process for authentication, provenance, traceability, and accountability for stakeholders.

A client initiates allocation of natural capital for a leverage [212] on a leverage

main screen, represented in FIG. 18, after being authenticated [502]. A client selects natural capital assets to use in a leverage [212] transaction and provides basic details of an upcoming transaction and who has permission to access details of natural capital, including its location, assessment history and details, and its current state. A client submits details as a leverage [212] transaction request. A facility operator reviews leverage [212] transaction request, confirms request, and activates a leverage [212] transaction.

Other parties receive notice of a client allocating natural capital assets to a leverage [212] transaction and instructions for how to gain access to view details of natural capital assets in order to arrange and finalize a leverage [212] transaction. Once a contract for use of natural capital assets is generated, a facility [101] monitors and reports out on natural capital and activities on agreements on a regular basis via email. A client and a facility [101] work together to ensure proper use of natural capital assets.

Natural capital assets used in a leverage [212] transaction may not be used in any other transaction but a client retains ownership. A client may cancel a leverage [212] transaction any time before natural capital assets are actually contracted to be used in a specific way, such as collateral for a loan.

At any point in a transaction flow [500], when natural capital is activated, assessed, and valuated, a user may track or trace [511] natural capital assets, and other capital assets, from anywhere there is connectivity to a portal [239].

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A natural capital management facility (101) housed in a shipping container (102), comprising:
an induction furnace (115) outfitted within an interior part of the natural capital management facility (101) for processing one or more precious metals;
a plurality of material analysis instruments (116) to perform elemental analysis, characterization, and assessment of a plurality of natural capital assets;
a data center (117) to house one or more of a network, computing, data, communication, and an application infrastructure (118);
a natural capital management software (200) to execute the data housed in the data center (117) when the natural capital management facility (101) is on-grid, or off-grid, and enables one or more users to remotely connect to the natural capital management facility (101) to conduct a plurality of activities;
a natural capital management software (200) to manage the activities associated with assessing, trading, and one or more other activities related to one or more of the natural capital assets or a plurality of physical capital assets;
a safe (119) to securely store one or more high-value materials;
a Heating, Ventilation, and Air Conditioning (HVAC) (141) and an air purifier (142) to control climate and purify the air throughout the natural capital management facility (101);
a plurality of connections, systems, and fixtures for power (150), water (145), and a hard-wired network (162) so that the natural capital management facility (101) operates off-grid when needed or to plug into one or more additional capacities when needed;
a plurality of sensors (156) and meters (157) to measure a plurality of variables inside the natural capital management facility (101) and one or more components;
a plurality of sensors (156) and a plurality of meters (157) to measure a plurality of variables inside the natural capital management facility (101), wherein the measured data is logged into a centralized logging, monitoring, and alert system, which is a component of the network, computing, data, communication, and the application infrastructure (118) housed in the natural capital management facility (101).

2. The natural capital management facility (101) as claimed in claim 1, wherein the shipping container (102) comprises:
a front entry (105);
a rear entry (106);
a plurality of lighting systems (107) positioned inside and outside of the shipping container (102) to provide visibility;
a plurality of video surveillance systems (108) positioned inside and outside of the shipping container (102) to provide security;
a structural wall (109) to divide a client compartment (110) and a work compartment (111);
a non-structural wall (109) to divide one or more client cubicles (120);
a penetration-resistant window (112) embedded in the structural wall (109), which sits between the client compartment (110) and the work compartment (111);
a solar array (113) placed on a roof (131) of the shipping container (102) housing the facility (101), providing a covered outside pavilion (126) and power (150) for off-grid operation when needed; and
a plurality of double doors (103) that lead into the interior part of the natural capital management facility (101), and are outfitted with a plurality of access control systems (104).

3. The natural capital management facility (101) as claimed in claim 1, wherein the material analysis instruments (116) comprising an X-ray fluorescence (XRF) analyzer.

4. The natural capital management facility (101) as claimed in claim 1, wherein, on an exterior part of the natural capital management facility (101), the natural capital assets are received and stored under a covered, and outside pavilion (126) that includes one or more areas designated for receiving area (132) and storage area (133).

5. The natural capital management facility (101) as claimed in claim 4, wherein the covered, and outside pavilion (126) is created from an overhang (129) from the solar array (113) attached to a roof (131) of the shipping container (102).

6. The natural capital management facility (101) as claimed in claim 4, wherein the receiving area (132) has a floor trade scale (143) for one or more bulk natural capitals.

7. The natural capital management facility (101) as claimed in claim 4, wherein the storage area (133) is used for the temporary storage of the bulk natural capitals.

8. The natural capital management facility (101) as claimed in claim 2, wherein the plurality of double doors (103) facilitate a client or a facility operator to enter the natural capital management facility (101), wherein the double doors (103) are controlled by the biometric access control systems (104).

9. The natural capital management facility (101) as claimed in claim 2, wherein the lighting system (107) and the video surveillance system (108) detect motion.

10. The natural capital management facility (101) as claimed in claim 2, wherein the client compartment (110) comprises one or more than client cubicles (120).

11. The natural capital management facility (101) as claimed in claim 2, wherein in the client cubicles (120), the client participates in transactions at a client commercial counter (138) outfitted with a touch screen computing device (137).

12. The natural capital management facility (101) as claimed in claim 1, wherein the shipping container (102) comprises: a multi-function biometric device (135) capable of enrolling and verifying a person's face, fingerprint, signature; and an input device (139).

13. The natural capital management facility (101) as claimed in claim 1, wherein the data center (117) is housed in a secure rack cabinet (125) to support the operation of a local area network (LAN) (162).

14. The natural capital management facility (101) as claimed in claim 1, wherein the natural capital management software (200) serves as a front end for the facility operator and enables the facility operator to run the operation of the natural capital management facility (101).

15. The natural capital management facility (101) as claimed in claim 1, wherein the natural capital management software (200) comprises an object onboarding process component (201); an object management process component (202); a transactions process component (203); and a system/component management process component (204).

16. The natural capital management facility (101) as claimed in claim 1, wherein the natural capital management software (200) comprises an object (240) having a unique record and a unique identification number.

17. The natural capital management facility (101) as claimed in claim 16, wherein the objects (240) comprising a single natural capital, a person, an animal, a transaction, an agreement, an assessment, and the object (240).

18. The natural capital management facility (101) as claimed in claim 15, wherein the object onboarding process component (201) and the system/component management process component (204) establish a structure and parameters for using the object management process component (202) and the process of a transaction component (203).

19. The natural capital management facility (101) as claimed in claim 15, wherein the object onboarding process component (201) enables setting up and activating the object (240).

20. The natural capital management facility (101) as claimed in claim 15, wherein the system/component management process component (204) manages the natural capital assets.

21. The natural capital management facility (101) as claimed in claim 15, wherein the object management process component (202) involves a plurality of management functions related to the object (240).

22. The natural capital management facility (101) as claimed in claim 15, wherein the transactions process component (203) is a plurality of functions to enable the activities related to trade and leverage of the natural capital, natural capital products, and other capital and assets.

23. The natural capital management facility (101) as claimed in claim 15, comprises a natural capital management software main screen (205) to facilitate the users to access the functions of the natural capital management facility (101).

24. The natural capital management facility (101) as claimed in claim 23, wherein the natural capital management software main screen (205) comprises a capital area, a transactions area, and a management area. Object onboarding is initiated through a capital profile (206) function.

25. The natural capital management facility (101) as claimed in claim 23, wherein the natural capital management software main screen (205) allows the users to initiate and complete a plurality of functions comprising a capital profile (206), a capital assessment (207), a capital inventory (208), a capital valuation (209), a pool (210), a trade (211), leverage (212), a track or trace (213), monitoring (214), a risk and security management (215), a capital management (216), and scenarios and decision support (217).

26. The natural capital management facility (101) as claimed in claim 25, wherein the users access a capital profile (206) function to onboard, manage, and inventory capital.

27. The natural capital management facility (101) as claimed in claim 15, wherein the object management process component (202) consists of functions comprising initiation of and updating object records (223); object assessment (224); object inventory management (225); object valuation (226); natural capital object management (227); natural capital cultivation/production management (228); object monitoring (229); and object archiving (230).

28. The natural capital management facility (101) as claimed in claim 27, wherein the object assessment (224) function establishes a plurality of standard protocols (238) for the assessment of a natural capital type in a natural capital management software (200).

29. The natural capital management facility (101) as claimed in claim 27, wherein the object valuation (226) function generates a timely valuation of a natural capital object (240) based on the latest, and historical, object assessments, and an underlying logic (241).

30. The natural capital management facility (101) as claimed in claim 28, wherein the natural capital object management protocols (238) are created for the object (240).

31. The natural capital management facility (101) as claimed in claim 27, wherein the initiation of and updating object records (223) is an ongoing activity.

32. The natural capital management facility (101) as claimed in claim 27, wherein the transactions process component (203) consists of functions including pool (210), trade (211), leverage (212), and track or trace (213).

33. The natural capital management facility (101) as claimed in claim 25, wherein the risk and security management (215) function support risk and security management (215) activities comprising identifying, monitoring, managing, and mitigating risks.

34. The natural capital management facility (101) as claimed in claim 25, wherein the capital management (216) function supports a plurality of capital management (216) activities comprising developing strategies and plans to improve capital management; inventorying and valuating natural capital at a cluster; setting use and application profiles and parameters for use and management of natural capital.

35. The natural capital management facility (101) as claimed in claim 25, wherein the data from the capital management (216) function is fed into a machine learning and artificial intelligence engine (237) that services scenarios and decision support (217) function and other system functions.

36. The natural capital management facility (101) as claimed in claim 25, wherein the scenarios and decision support (217) function uses data from a plurality of elements.

37. The natural capital management facility (101) as claimed in claim 35, wherein the machine learning and artificial intelligence engine (237) simulates human intention, intelligence, and adaptability in performing tasks and making decisions, and learning by experience with or without human intervention.
